(19) United States
(12) Patent Application Publication
(10) Pub. No.: US 2011/0137787 A1
(43) Pub. Date: Jun. 9, 2011

(54) TRADING SYSTEM AND METHOD

(75) Inventor: Leon YOHAI-GIOCHAIS, Attiki (GR)

(73) Assignee: Dayo Innovative Trading Limited, Nicosia (CY)

(21) Appl. No.: 12/796,966

(22) Filed: Jun. 9, 2010

Related U.S. Application Data
(63) Continuation of application No. 11/673,660, filed on Feb. 12, 2007, now abandoned.
(60) Provisional application No. 60/862,317, filed on Oct. 20, 2006.

(51) Int. Cl. G06Q 40/00

(52) U.S. Cl. 705/37

(57) ABSTRACT

The present invention provides an on-line trading system and method for ordering and executing trades in financial markets, such as foreign exchange markets. The system and method permit account holders to automatically trade in one or more markets based on recommendations provided by signal providers, without the need for the account holders to make decisions about each trade to be made. A database of account holder preferences and trading parameters is maintained and consulted upon receipt of advice for a trade, and trades are executed if and when a selected signal provider provides suitable advice.

### CROSS-REFERENCE TO RELATED APPLICATIONS

The present application relies on the disclosure of and claims the benefit of the filing date of U.S. provisional patent application No. 60/862,317, filed on 20 Oct. 2006, the entire disclosure of which is hereby incorporated herein in its entirety by reference.

### BACKGROUND OF THE INVENTION

1. Field of the Invention

The present invention relates to the field of finance. More specifically, the present invention relates to systems and methods for buying and selling in markets in the financial sectors of individual countries or the entire world economy. The present invention may be applied, for example, to foreign currency, options, and futures trading.

2. Description of Related Art

Trading in financial markets has traditionally been limited to professional traders representing high net value clients or business interests. However, with the advent of the Internet and the accessibility it provides to the population in general, more and more individual persons are entering trading markets through on-line trading services or even on their own. However, due to the complexities of the various trading markets, and the differences between how each trading market operates, it is still quite difficult for an average person to enter a market and execute trades effectively and with confidence that trades are being executed as desired.

Numerous systems have been developed to assist individuals with on-line trading. For example, training systems to teach individuals how to understand financial markets and system have been developed. Included among these is that disclosed in U.S. Published Patent Application No. 2005/0233286 of Colaio et al. Colaio et al. discloses systems and methods that enable students to participate in a simulated, electronic trading environment to educate them on the trading of financial products.

Likewise, commercial systems are available to investors, which assist the investors in trading in financial markets. For example, U.S. patent application publication number 2005/0283427 to Owens et al., which relates to the commercial system FX Engines (fxengines.com) provides an Internet-based trading system that automatically orders trades for clients. The system correlates pre-defined user selected parameters for trading with market data, and automatically orders trades to be made for the users based on the parameters selected. In addition, services from Fxall (fxall.com), Reuters (reuters.com), ActionForex (actionforex.com), Forex-Markets.com (forex-markets.com), and FXSpyder (fxspyder.com) provide on-line trading systems for financial markets, including foreign exchange markets.

In addition, a system provided by FX-Auto (fx-auto.com) allows users to set up accounts and order trades based on recommendations of one or more signal providers. Prior to the priority date for the present document, FX-Auto provided users the ability to execute trades based on recommendations from signal providers. In that system, signal providers (3^{rd} parties that recommend to buy or sell a financial instrument) from all over the world posted their opinions electronically, and FX-Auto executed the recommendations for clients of FX-Auto that agreed with the opinions. According to that system, the FX-Auto client signed a stand-alone agreement with the signal provider, then downloaded a desktop software program to enable the recommendations of the signal provider to be executed on the client's behalf as trades. The system, however, was limited to use of a downloaded program resident and operating on each account holder's personal computer, and allowed for execution of trade by only one broker.

Although there have been numerous solutions devised for assisting individuals in trading in financial markets, there still exists a need in the art for systems and methods that are convenient to use and provide individuals with the ability to execute trades with confidence that such trades are being executed based on user preferences and without the need for each individual to become highly educated in each market and to monitor each market so that trades are effected properly.

### SUMMARY OF THE INVENTION

The present invention addresses needs in the art by providing a system and method for trading in one or more financial markets, such as in foreign currency markets. In general, the system involves an on-line hub that receives communications from multiple signal providers, parses those communications based on the identity of the providers and on parameters selected by account holders, and places orders with brokers for the account holders based on information in the communications from the signal providers. According to the method of the invention, in general, account holders select one or more signal providers to provide information on which trading decisions are to be made; indicate the amount or percentage of their account to be traded; optionally indicate one or more other parameters that are relevant to trades of interest; and authorize one or more trades to be ordered by the system of the invention. Typically, the system orders one or more brokers to execute trades for the account holders based, at least in part, on information from the signal provider(s).

Unlike other systems in the art, the system of the present invention eliminates the need of customers to sign up with a signal provider and pay that signal provider a fee for his advice. Rather, the customer simply opens an account with the present system, identifies one or more signal provider to rely on for advice, and indicates what actions to take upon receipt of advice from each signal provider. The signal provider is not paid directly by the customer. Instead, the signal provider is paid by the operator of the present system, as a portion of the commission for execution of trades. In contrast to other systems, in the system of the present invention, there is no need to download an application onto a local computer used by the customer; there is no need for the customer to contract directly with each signal provider of interest (e.g., there is no need for subscription fees); the user can hedge positions from different signal providers; the user can reverse trade based on recommendations from certain signal providers (i.e., execute an opposite trade as that recommended by a signal provider); the user can alter stops and limits; the user can use as many systems as desired (in embodiments, for free); the user can trade manually; or two or more of these features can be selected or utilized by a user.

The system of the invention comprises computer software and hardware. The hub, which is typically one or more servers or other computing devices connected to the Internet, comprises both hardware and software that act together to enable one or more account holders to select one or more signal providers to provide advice or other information on trades in financial markets, such as the foreign currency exchange markets. The hub also enables one or more account holders to order trades by their respective brokers based, at least in part, on the advice or other information provided by the signal provider(s). The system typically comprises software resident on a computer at a location distant from the account holder(s), but may, in embodiments, comprise software that is resident on the account holder(s) local computing device. In general, the software comprises instructions that execute methods of the invention. Typically, the system comprises one or more databases that contain information about account holders and parameters selected by those account holders relating to execution of trades.

The invention also provides a method of trading in one or more financial markets. In general, the method comprises: providing at least one computing device that is connected to the Internet; providing access to the device for one or more local computers used by one or more account holders; providing access to the device for one or more signal providers; and communicating with one or more brokers for the account holders, where the communications relate to trades in one or more financial markets for the account holder(s), and the trades are to be executed based, at least in part, on advice or other information provided by the signal provider(s). Typically, the method comprises receiving from at least one account holder parameters for executing trades in at least one financial market. Typically, the method also comprises receiving from at least one signal provider at least one e-mail with advice on a trade to make in a financial market. In addition, typically the method comprises sending at least one e-mail to at least one broker for at least one account holder, where the e-mail comprises an order for at least one trade to be executed in at least one financial market.

Accordingly, one aspect of the invention is software for carrying out a method of on-line trading. In general, the software is computer software that executes one or more embodiments of a method of the invention. The software may be resident on one or more computers, such as servers connected to the Internet, or may be resident on one or more storage media that are removable from a computer. For example, the software may be resident in the random access memory (RAM) of an Internet server, may be resident on a hard drive of an Internet server, or may be resident on an optical disk, such as a CD or DVD.

Additionally, the invention provides a method of doing business using a computer, and more particularly, using the Internet. In general, the method comprises: a) providing a system that i) maintains a database of parameters relating to trading in one or more financial markets by one or more account holders, ii) receives information from one or more signal providers relating to trading in one or more financial markets, iii) consults the database(s) to determine trades to be made for account holders based on the information received, and how much to trade, and iv) orders brokers for the account holders for which trades are to be made to execute those trades; and charging a fee for providing the system. In embodiments, the fee is charged to the account holder(s). In other embodiments, the fee is charged to the broker(s). In yet other embodiments, the fee is charged to both the account holder(s) and the broker(s). In some embodiments, revenue is shared with the signal provider(s).

### BRIEF DESCRIPTION OF THE DRAWINGS

The accompanying drawings, which are incorporated in and constitute a part of this specification, illustrate several features or embodiments of the invention, and together with the written description, serve to explain certain principles of the invention.

FIG. 1 depicts a flow chart of steps involved in an embodiment of a method of the invention for trading in a financial market.

FIG. 2 depicts schematically components and the flow of information in an embodiment of a system of the invention for trading in a financial market.

FIG. 3 depicts a screen shot of an embodiment of a sign-up web page that allows users to set up an account with the system.

FIG. 4 depicts a screen shot of an embodiment of an account set-up web page that allows users to select various options and settings for their accounts with the system of the invention.

FIG. 5 depicts a screen shot of an embodiment of a sign-up web page that allows signal providers to enroll with the system of the invention.

### DETAILED DESCRIPTION OF VARIOUS EMBODIMENTS OF THE INVENTION

Reference will now be made in detail to various exemplary embodiments of the invention, examples of which are illustrated in the accompanying drawings. It is to be understood that the following description is provided to give the reader a more detailed understanding of certain embodiments and features of the invention without restricting the invention to any particular embodiment, feature, or combination disclosed. It is also to be understood that the various embodiments and features may be combined in any fashion to provide alternative embodiments of the invention.

In one aspect, the invention provides a method of trading in one or more financial markets. As used herein, a trade is any action that results in a change in information being associated with an account holder's account. Typically, a trade is an action that results in a change in status of an account holder's financial holdings in one or more markets, such as buying foreign currency, selling foreign currency, orders to buy or sell when a currency reaches a pre-set value, and the like. It also may be an instruction to refrain from taking any action until a certain pre-defined condition is met, such as a date is met, a time within a give day is met, or the like. Furthermore, as used herein, a financial market is any market in which money can be used to buy and sell things. For example, a market may be a currency market, such as a foreign exchange market. Other non-limiting examples of markets for which the method may be used are: commodities, stocks, bonds, interest rates, equities, futures, and real estate markets.

In general, the method of trading comprises: providing at least one computing device that is capable of sending and/or receiving communications from the Internet; providing access to the device for one or more local computers used by one or more account holders; providing access to the device for one or more signal providers; and communicating with one or more brokers for the account holders, where the communications relate to trades in one or more financial markets for the account holder(s), and the trades are to be executed based, at least in part, on information (e.g., advice regarding trading) provided by the signal provider(s).

It is important to note at this point that, as used herein, the act of “providing” does not imply any physical location for any hardware, software, or communication routing. Rather, if any hardware, software, service, or feature of the invention, which is integrated into and as part of a method or system of the invention, is provided within a geographical area (e.g., the United States of America), it is to be understood that all hardware, software, service, or feature that is part of the system is considered to be “provided” within that geographic area. For example, if a computing device that is capable of sending and/or receiving communications from the Internet (e.g., a server) is provided or is part of a system of the invention, and the server is physically located outside of the U.S. borders but other steps of a method or components of a system are located within the U.S. borders, the method or system as a whole is considered to be within the U.S. borders because the portion of the method or system outside of the U.S. was provided as part of the method or system within the U.S. borders. Likewise, use of a system or method is considered to be within the U.S. if either or both the user and/or the hardware/software is located within the U.S.

Although not limited in its classification or configuration, typically, the computing device is a server connected to the Internet, which can receive and send information to other computing devices connected to the Internet. The device may comprise a database of information relating to account holders and/or signal providers. Alternatively, the device may be connected to one or more other devices, which comprise one or more such databases. Standard communications connections and protocols may be used by the device(s) to communicate with each other and other computers on the Internet. For example, the devices may accept and send information by way of e-mail (SMTP protocol), web queries (HTTP protocol), or any other useful protocol for transmitting information over the Internet or between communication devices. Connections may be by way of any known method, such as by way of physical wiring or through electromagnetic radiation communication (e.g., radio waves, microwaves, optical waves, infrared waves, etc.).

As mentioned above, the method comprises providing account holders access to the computing device. According to the invention, an account holder is an entity (i.e., natural person or business entity) that has provided adequate uniquely identifying information about himself, has provided adequate funds for execution of one or more trades in one or more financial markets, and has provided adequate instructions for how to administer his account. Within the context of the system of the present invention (discussed in detail below), an account holder can be an entity that has created an account with the system of the invention. The method of the invention can provide access to multiple account holders at any one time.

According to the invention, an account holder also has an account with an external broker. This characteristic flows from the method of trading provided by the invention. More specifically, the method of the invention receives information from one or more signal providers, identifies account holders who are interested in it, determines whether one or more trade for each account holder should be made based on the information, and orders one or more brokers to execute those trades, where the brokers who receive orders are only those brokers that also have accounts for the account holders. In essence, the method of the present invention does not actually execute the trades stipulated by the account holders, but rather orders the account holders' respective brokers to execute trades, based on pre-set parameters of the account holders' accounts and on information provided by the signal providers. As trading is now substantially automated, the act of ordering a trade is tantamount to executing the trade.

Providing access to account holders can be by any suitable method. Typically, the access is provided by way of a secure account for the account holder, which is maintained on the computing device or another device in communication with the computing device. The account comprises one or more piece of uniquely identifying information about the account holder to ensure security. Typically, the account comprises some unique combination of identifying information about the person or business entity, such as, but not necessarily limited to, name, address, social security number, family history, e-mail address, banking institution, password, and the like. Any type of uniquely identifying information may be used, and may be used in conjunction with funds transfer protocols to effect transfer of money into and out of the account, as required for payment of fees and/or deposits of earnings. It also typically comprises an account number or code and a database of information relating to the account holder's account and trading parameters. Access to the account by the account holder can be through any communication means, but is typically by way of a secure web page on the Internet.

Providing account holders access to the computing device allows for interaction between the account holders, the operators of the presently disclosed methods and systems, and the account holders' brokers. It also provides the account holders the ability to monitor and modify their accounts. In general, account holders can access their accounts and make changes at any suitable time, and the changes can take place immediately. Of course, where the changes are inconsistent with the account settings (e.g., inadequate assets to execute trades) or impermissible under applicable law, the changes might not be implemented. In such situations, the access provided to the account holders can also function as access for the practitioner of the invention to the account holder, typically to inform the account holder of the inability to make the changes to the account specified by the account holder. Other information may be provided to the account holder as well through this access.

The account typically comprises a database of information relevant to the account holder. In general, the database can comprise: information relating to the assets in the account; the signal provider(s) selected by the account holder as providers of information for trading; the actions to take based on information provided by signal providers; and pre-selected parameters for execution of trades (e.g., upper and lower prices for buying and selling of currencies, stocks, bonds, commodities, etc.). The database may be updated periodically (e.g., hourly or more often, daily, weekly, monthly, yearly or less often) by the account holder to reflect changes in account parameters, such as deposits or withdrawals of assets from the account, changes in selected signal providers, changes in amounts to trade based on advice from signal providers, changes in trading minimums or maximums, and the like. The database may also be updated periodically by the operator of the method (or system, as detailed below), to reflect various changes to one or more account holders' accounts. Changes to the database are not particularly limited, and in general may be any changes that are suitable for practicing the method and administering and maintaining the system of the invention. As a general matter, for ease of implementation, the database is typically provided as a compilation of the account parameters of some or all account holders, where each account holder is provided access to only the information that is relevant to his account.

The method of trading also comprises providing access to the device for one or more signal providers. As used herein, a signal provider is a person or collection of persons who provide advice or other information on trading in one or more financial markets. In general, a signal provider is knowledgeable in one or more financial markets and closely tracks those markets and the trends within those markets. Typically, the signal provider uses his knowledge to give advice on how to manage funds in the markets. For example, a signal provider will periodically advise others to buy or sell within a financial market, such as to buy one nation's currency and sell another nation's, to buy stock for a certain company when it reaches a certain price, sell all stock in a particular industry, and the like. Signal providers also may advise others on the amounts to buy or sell. Many such signal providers are know in the financial markets, and any such signal provider is envisioned by the present invention. Non-limiting examples of signal providers are: Acetrader, OmiFX, Prosignal, ForexRulezDTBO1, ForexRulezDTBI1, ForexRulezDTBI2, HawkFX, CurrencySpec1, CurrencySpec2, Entropia, SignauxForex, USD/CAD Mover, Broadsword Forex, Daily FX System, Monaco, RT Forex North, Pipraker, FXMaster, and Aestreux Fund.

As with access to the computing device for account holders, access for signal providers may be accomplished in any suitable way. For example, it may be by way of e-mail to one or more e-mail accounts provide by or accessible by the computing device. It likewise, may be by way of access, for example secure access, to a web site provide by or accessible by the computing device. Other means for providing access are envisioned as well, and those of skill in the art can immediately recognize those without the need for each to be specifically listed herein. In preferred embodiments, the computing device receives information from the signal providers by way of e-mail communications. The e-mail communications contain information of interest to the account holders, such as advice on trading in a financial market. While the information may be provided in any way, in embodiments it is provided as a simple message in the subject heading of an e-mail. For example, an e-mail from a signal provider may be received, where the subject line simply states “Buy USD/EUR”, meaning buy U.S. dollars with Euros. The method of the invention provides for access to multiple signal providers at one time.

In embodiments, the advice of one or more signal providers is weighted, based on user selection during the set up period or at a time when account parameters are revised. For example, an account holder may value the advice of one signal provider more than one or more other signal providers, and desire to trade a higher percentage of his account based on the advice of the preferred signal provider, as compared to other selected signal providers. The account holder thus may select, for example, to trade 2 lots based on advice of a particular signal provider, while selecting to trade only 1 lot based on advice of another signal provider. Any combination of weighting for any number of signal providers is possible, providing the account holder a great deal of flexibility and control in managing his trades. It should be noted here that the term “based on advice or other information” from a signal provider means that the decision is made after consideration of the information. It thus may include many different types of trades and decisions, including, but not limited to: trading exactly according to the advice of the signal provider; trading exactly according to the opposite of the advice of the signal provider; trading according to the advice of the signal provider, but in an amount that is less or more than advised; and trading according to the advice of the signal provider, but only if other criteria are met, such as minimum price.

According to the method of the invention, the method also comprises communicating with one or more brokers for the account holders. As mentioned above, the account holder will also have an account with a broker, who is authorized to execute trades for the account holder. The method of the invention contemplates knowledge of a correlation between each account holder and his respective broker(s). This correlation is typically maintained as part of the database. According to the invention, the method automatically instructs the broker to execute one or more trades for the account holder when the parameters set by the account holder for his account indicate that a trade should be executed. The instructions can be sent at any time of the day, and, because the trades are to be executed based on pre-defined conditions set by the account holder, trades may be executed without further input by the account holder. In this way, the account holder can execute trades without needing to constantly monitor markets of interest, and can even execute trades while sleeping or attending to other business.

Trades ordered by the method of the invention are based on pre-defined criteria, set by each account holder for his account. They are also based on information provided by one or more signal providers. For example, an account holder may stipulate in his account that all trades advised by a particular signal provider should be immediately executed upon receipt of that advice by the computing device. When such advice is received, the trade or trades advised by the signal provider will be immediately forwarded to the appropriate brokers for the account holders, and the brokers will immediately execute the trade(s). Thus, if the account holder is a resident of the U.S., and a signal provider selected by the account holder for trade advice advises that traders should buy Japanese yen with U.S. dollars, the account holder will be able to immediately buy yen with U.S. dollars, even though the account holder might be asleep at the time of the trade.

Although not limited to any combination of communication methods, typically, the method comprises receiving from at least one account holder parameters for executing trades in at least one financial market. Typically, the method also comprises periodically receiving from at least one signal provider at least one e-mail with advice on a trade to make in a financial market. In addition, typically the method comprises sending at least one e-mail to at least one broker for at least one account holder, where the e-mail comprises an order for at least one trade to be executed in at least one financial market and is sent immediately (e.g., less than two minutes after receipt of information from a signal provider, and preferably less than one minute, less than 30 seconds, less than 10 seconds, less than 2 seconds, and less than 1 second).

As a non-limiting example of the method of the invention, the following scenario may be seen: an individual person sets up an account on or through a communication device, where the account stipulates three signal providers (A, B, and C) whose advice on trades should be followed, in a proportion of $10,000 traded on advice from A, $10,000 on advice from B, and $15,000 on advice from C); a database entry is created for the account holder (account holder 1), indicating that all trades advised by A, B, and C are to be executed in the amounts indicated; one hour later, the communication device receives an e-mail from A, stating in the subject line “Buy USD/JPY”; the communication device consults the database to determine which account holders trade based on signal provider A advice; account holder 1 is identified, and the amount to trade is determined and the foreign exchange broker for account holder 1 is determined; a communication is sent immediately to the foreign exchange broker for account holder 1, indicating that $10,000 U.S. dollars should be bought and the equivalent amount of Japanese yen sold. It is to be noted that, at no time since the set up of the account, was input from the account holder required. The desired trade was executed according to the account holder's wishes, without his needing to be involved in the trade, or even knowing that a trade had occurred. This feature of the invention permits investors to execute trades without requiring constant monitoring of financial markets and constant submission of orders for trades. This is particularly advantageous where multiple trades are desired per day, where multiple markets are traded, and where markets of interest are open at inconvenient times. For example, the foreign exchange markets are open 24 hours a day, and much trading occurs during sleeping hours (regardless of the country in which a person resides). The method of the present invention permits trading while the account holder sleeps or pursues other activities.

In some embodiments, the invention provides a method for effecting one or more trades from two or more account holders in one or more financial markets using one or more signal providers. That is, the method of the present invention is robust and can comprise receiving and sending information relating to multiple account holders and multiple signal providers at the same time. In general, the method as practiced in these embodiments comprises: maintaining at least two separate accounts, one for each of two different account holders; maintaining a database of parameters that are specific for each account, wherein at least one parameter is an action to be taken regarding trading based on advice or other information provided by a signal provider; receiving advice or other information from at least one signal provider; determining which accounts for which trading action should be taken; determining what amount of money is to be traded for each; determining which brokers should be ordered to take action for the account holders; and ordering that such action be taken by the appropriate brokers. In certain embodiments, the method comprises combining all of the orders for one broker into a single order, and sending that single order. In embodiments, the method comprises memorializing trades that are ordered, and optionally providing information regarding the trades to the account holders. In embodiments, trades are ordered for multiple account holders based on information provided by a single signal provider. In many embodiments, multiple brokers are ordered to execute trades based on a single communication from a single signal provider.

As should be evident, in some embodiments, the method comprises ordering trades for multiple account holders based on advice from one signal provider. Although it is possible to place one order for each account holder, it is often most convenient to bundle all orders for a particular broker into a single order. When doing so, the method of the invention can comprise tracking each individual account holder's portion of the total order, where such tracking can be performed by an entity operating a system of the present invention, or where such tracking can be performed by the broker(s) involved.

In yet other embodiments, the order sent to a broker reflects the total of orders for that broker placed within a pre-determined amount of time by all account holders, based on information from all signal providers. For example, an order may be placed for execution of a trade by a broker, where the order may include the sum of all orders for all account holders who also have accounts with that broker, based on information or advice from all signal providers received in the previous two minutes. As a specific exemplary scenario, account holders 1-4 all have accounts according to the method of the present invention and also have accounts with the same foreign exchange broker. The method also provides the ability to select from among signal providers 1-8. Account holder 1 executes trades based on advice provided by signal providers 2 and 8; account holder 2 executes trades based on advice provided by signal providers 1, 2, and 10; account holder 3 executes trades based on advice provided by signal provider 2; and account holder 4 executes trades based on signal provider 6. Within a two minute period, the communication device receives trade advice from signal providers 1, 2 and 5, all of which indicated that traders should buy Euros and sell U.S. dollars. At the end of the two minute period, the method determines which account holders trade based on advice from signal providers 1, 2, and 5, determines what types of trades to perform and how much to trade, sums all of the trades, and orders a single trade from the broker.

It can be envisioned that summation of multiple trades for multiple account holders, or even the ability of a single account holder to make trades based on advice from multiple signal providers, may result in apparent self cancellation of trades (hedging). For example, in the above scenario, account holder 1 executes trades based on advice from signal providers 2 and 8, while account holder 4 executes trades based on advice from signal provider 6. It is possible that, within a given period of time (however small or large), signal provider 2 might advise traders to sell U.S. dollars and buy Euros, while signal provider 6 advises buying U.S. dollars and selling Euros. In this situation, a broker receiving a summed order will not see the two trades, but will instead see the net result of the two trades, which can be to buy U.S. dollars and sell Euros (if the amount to buy/sell from account holders 1 and 4 favors the advice of signal provider 2), to buy Euros and sell U.S. dollars (if the amount to buy/sell from account holders 1 and 4 favors the advice of signal provider 6), or to take no action (if the amount to buy/sell is the same from account holders 1 and 4). However, in such a situation, the method of the present invention can keep track of the actual orders for each account holder, and rectify the accounts accordingly, for the first time. Accounting issues regarding actual trades can be handled periodically based on data retained by the method and system, and in conjunction with records kept by each broker.

It thus may be seen that the present invention can provide for a single source that subscribes to and receives data from multiple signal providers, such that multiple users may each have trades automatically made for them based on the data from one or more of the signal providers. A mechanism may be provided to allow a relatively large number of trades per user (e.g., at least 100 trades per month per user, at least 250 trades per month per user, at least 500 trades per month per user, at least 1000 trades per month per user, or at least 3000 trades per month per user, or more). The number of users of the system at any one time is not particularly limited, and can be large (e.g., at least 10 users, at least 100 users, or more). Likewise, a large number of signal providers can have access (e.g., at least 5 signal providers, at least 10 signal providers, at least 20 signal providers).

Of course, where combining orders from multiple account holders based on advice from multiple signal providers occurs, the pre-determined amount of time between placement of orders may be any amount of time, but is preferably very short to better reflect the wishes of the account holders, which typically include executing trades as soon as possible after receiving advice from signal providers. Accordingly, the amount of time may be anywhere from one second or less to one day or longer. Owing to the speed of the Internet and computer communications, the time period may be quite short, and even less than one second, which is similar to the situation where combining of orders does not occur.

Optionally, the method can comprise reporting to each account holder the status of his account. This can be accomplished in numerous ways, as is understood by those of skill in the financial trading field. For example, the account holders may be provided a chart or graph, showing their investments in one or multiple markets, which may also show overall performance characteristics of the market over a given period of time. Alternatively or in addition, account holders may be provided tables showing their account information, which may include amount invested, markets selected, signal providers selected, amount of money made, amount of money lost, and other information of interest to the account holder. The act of reporting can be accomplished by those operating a system of the invention, or by a broker for the account holder. Furthermore, the information may be supplied to the account holders in any suitable way, such as by e-mail or by access to a web page on the Internet.

One feature of the method of the invention is the ability to parse communications, such as e-mails, from signal providers to allow for placement of orders to brokers. By use of the database of the invention, individual account holders can be identified who are interested in making trades based on advice or other information provided by particular signal providers, but not others. More specifically, the method of the invention provides the ability for account holders to select from among multiple signal providers, where one, many, or all of the signal providers may be selected and the information provided by them used to execute trades. The methods of the invention use one or more databases to correlate the accounts with their respective selected signal provider(s), and order trades for those accounts only when information is received from the selected signal providers.

When setting up accounts, account holders typically may select any number of signal providers, and indicate what types of actions to take based on information provided by each signal provider. Thus, an account holder may indicate that a certain amount of money from his account is to be traded based on information from a particular signal provider, or a certain percentage of his funds is to be traded. The method of the invention also provides the ability to execute trades based on multiple parameters, including, but not limited to the number of signal providers to rely on for advice. For example, account holders may provide pre-set conditions for trading, which may be used as an over-ride to advice provided by one or more signal provides. One non-limiting example involves an account holder who may set stops or limits for prices of currencies, which will bar trading even in situations where a selected signal provider has advised a trade. Another non-limiting example involves an account holder who may order trades by a signal provider, but only if the advice agrees with one or more other selected signal provider. As can be envisioned, any number of parameters can be set, where the parameters may be selected from those known in the art as useful in trading in the various financial markets.

In the method of the invention, because the method allows for orders to be placed based on information from multiple signal providers, and because the method allows for orders to be placed in multiple financial markets, each account holder may place one or more orders at any given time. The orders may be orders for one broker to execute, or may be orders for multiple brokers to execute. In addition, the method can accommodate orders from multiple account holders over the same period of time, including multiple orders from multiple account holders at the same time. The method is not particularly limited in the number and types of orders that may be communicated. As a practical matter, when implemented as part of a web-based system, the only limiting factor will be the bandwidth available to the practitioner. Where adequate bandwidth is available, the method will be able to process an unlimited number of orders in a given amount of time.

As discussed above, in general, the method of trading comprises trading based on information provided by one or more signal providers. Typically, a user will select one or more signal providers and rely on those signal providers' normal activities to trade. Thus, in many embodiments, one or more signal providers with good track records in investing and trading will be selected. The advice of those signal providers will be followed. In this way, the account holder will not be required to monitor the market, monitor the advice of the signal provider, and order trades from a broker. Rather, the process is automated, and the account holder is free to pursue other interests while his account is being administered according to his pre-set parameters. Of course, as time changes, the account holder may wish to revise his trading strategy. Accordingly, in embodiments, the method of the invention comprises permitting the account holder to modify account settings or parameters to reflect new strategies or to reflect new beliefs regarding the signal providers. It also allows account holders to update their accounts as new signal providers become available and old signal providers become no longer available.

Although it is envisioned that many account holders will select one or more signal providers based on the good track records of the signal providers, in some embodiments, referred to herein as “reverse trading” embodiments, an account holder may select one or more signal providers having poor records of investment decisions, and place orders based on those providers. For example, an account holder may select the worst five performers over a given period of time (e.g., twelve months), and place orders based on the opposite action taken by those signal providers. Thus, when each of the selected signal providers issues a recommendation to sell, the account holder will place an order to buy, and vice versa. In this way, one may expect, on average, to have a successful investment strategy.

Likewise, where multiple signal providers are selected, an account holder may wish to select to signal providers that generally have opposite successes over a period of history. That is, looking at historical data, it might become evident that two signal providers have essentially opposite trading philosophies, which are reflected in their respective performances over time. An account holder may wish to select these two signal providers as a hedge against large swings in the value of his account.

One feature provided by embodiments of the method of the invention includes the ability to recognize and separate trades based on the amount of input from the account holder. For example, the method is capable of determining whether an order was manually submitted or automatically submitted. More specifically, for every recommendation from a signal provider, there is an electronic record of communication of the recommendation (e.g., an e-mail message). The method and system track all communications, and compare them with open or closed trades for each account holder. When the number of recommendations relevant to the account holder and the number of trades ordered differ, then the method and system can conclude that the trade was executed manually. In this way, user intervention does not affect the service in general, but rather simply alters the user's own portfolio. For example, a user may use the method to automatically trade according to pre-defined criteria (e.g., based on trades executed by selected signal providers) while additionally manually trade based on other criteria.

The method of the invention optionally comprises receiving from each broker confirmation of execution of orders. As the method allows for pooling of orders, the information received from each broker might not include adequate data to correlate each order with each account holder. However, because the method provides for correlation of orders with account holders, for example by tagging each order with uniquely identifying information, the method of the invention can parse out the information received from the brokers and route the relevant information to each account holder.

Typically, the method of the invention is implemented using a computer system connected to the Internet, and thus typically, the steps of the method, such as receiving information from signal providers and ordering trades from brokers, comprise receipt or submission of electronic information, such as e-mails or by uploading of information directly to a web page. Of course, other means of information transfer can be used, such as telephony (land lines and wireless), text messaging, instant messaging (IM), RSS feeds, HTTP, SMTP, XML, and the like.

In embodiments, the method comprises use of a computer system, such as one comprising at least one computing device, software, at least one user (e.g., account holder), and at least one signal provider. In such embodiments, the method may comprise: providing at least one computing device that is connected to the Internet; providing access to the device for one or more local computers and one or more signal providers; receiving at least one communication from the signal provider(s); determining which trades to order based on the information received from the signal provider(s) and information provided by account holders; and ordering one or more trades by one or more brokers in one or more financial markets. Typically, the local computers are controlled by at least one human user, such as an account holder, although in embodiments they may be automatically controlled by software running a computer program. The computing device is often a server on the Internet, which provides a hub for communications between the local computers and the signal providers.

In another aspect, the invention provides software. In general, the software comprises computer instructions to execute some or all of the steps of at least one embodiment of the method of the invention. Thus, the software may be software for carrying out a method of on-line trading in one or more financial markets. In exemplary embodiments, the software is for carrying out an on-line method of trading in foreign exchange markets for currency.

Software according to the invention may be any set of instructions that are executable by a computing device, as recognized in the art of computers. The instructions thus may be written in any computer language (e.g., C++, Visual Basic, JAVA) and may be executable on any computing machine (e.g., PC, Mac, Internet server, cell phone) using any operating system (e.g., UNIX, Mac OS, Microsoft Windows, LINUX). The software also may take the form of either source code or object code. Furthermore, the software may comprise multiple physical or functional units, which may be combined to create a single functional unit that executes an embodiment of a method of the invention. Thus, for example, the software may comprise multiple computer programs and files, one or more portions of which may be physically located on or connected to one piece of hardware, while one or more other portions of which may be physically located on or connected to another piece or pieces of hardware. Connection of the pieces of hardware permits combining of the various portions of the software to create a functional unit. As such, executable files may be located at a site that is physically distinct from data files, such as those comprising one or more databases.

The software of the invention comprises computer executable instructions for providing an on-line method of trading in one or more financial markets. In embodiments, the software comprises computer executable instructions for trading in foreign exchange currency markets. In general, the software comprises one or more programs and/or data files or data sets that permits one or more account holders to specify trades based at least in part on information provided by one or more signal providers. The software executes instructions that enable one or more computers to receive information from one or more signal providers (e.g., by receipt of e-mails), to use that information to identify account holders for which trades should be made, and to order trades for those account holders by communicating with one or more brokers.

The software may be resident on one or more computers, such as servers connected to the Internet, or may be resident on one or more storage media that are removable from a computer. For example, the software may be resident in the random access memory (RAM) of an Internet server, may be resident on a hard drive of an Internet server, or may be resident on an optical disk, such as a CD or DVD. It likewise may be resident, partially or wholly, on the hard drive or other storage media of a personal computing device of an account holder.

Accordingly, in one aspect, the invention provides a storage medium comprising software of the invention. The storage medium may comprise some or all of the programs and data files needed to execute an embodiment of the method of the invention, and, where it does not comprise all, may be used in conjunction with a computing device that can supply, either directly or by way of connection to one or more other computers, with the remainder of the necessary programs and data files. The storage medium can be any medium capable of storing a computer program. It thus may be any medium known to be useful within the computer field for storing computer programs or data, such as random access memory (RAM), a hard drive, a memory stick, a floppy disk, an optical drive, an optical disk (e.g., a CD or DVD), and the like. In embodiments, the storage medium is a portable storage medium, which can be inserted or removed from a machine as a user desires.

In yet another aspect, the invention provides one or more databases containing data files, etc. containing information relevant to executing at least one embodiment of the methods of the invention. In embodiments, the database(s) comprise information regarding account holders and their respective accounts. The databases generally correlate accounts with investment or trading parameters, including, but not limited to, which signal providers to rely on for trading advice or other information, account balances, amounts to trade based on identities of signal providers, and other trading parameters such as limits, stops, trailing stop losses, and the like.

In another aspect, the invention provides a system for on-line trading in one or more financial markets. In general, the system of the invention comprises computer software and computer hardware. In its basic form, it comprises at least one computing device, which is typically a server connected to the Internet. As used herein, this device is also referred to herein as a “hub” to evoke the concept of its placement within a communication environment, between multiple account holders, multiple signal providers, and multiple brokers. As is evident from the disclosure above, the computing device is capable of communicating with one or more account holders, one or more signal providers, and one or more brokers. The computing device is also capable, when it comprises or is provided with appropriate software, of maintaining and administering accounts for account holders, and placing orders for account holders. The software of the system provides computer-executable instructions for performing one or more embodiments of the methods of the invention.

The system of the invention may comprise a single computer or a combination of multiple computers connected over a network, such as the Internet. In embodiments, it comprises two or more computers connected together to act as a hub. The computers may share tasks associated with running the system, or may act as mirror sites for each other, permitting a higher volume of traffic by balancing of loads or by providing geographically proximate servers for users in different parts of the world. Control of the computers within the system may be under those practicing the invention, but where local computers are involved, the local computers are typically controlled by account holders or others who provide the local computers to the account holders.

Accordingly, the systems may permit the practitioner to provide on-line trading services to any person who has access to the Internet, such as, but not limited to, network users on a small, highly controlled network (e.g., a workplace network), on a network that has users over a defined geographic region (e.g., customers of an ISP), or on a network that has users throughout the world (e.g., the Internet). Indeed, while the present disclosure discusses the methods and systems in terms of the Internet, it is to be understood that the invention may be practiced within the context of any network that comprises account holders, signal providers, and brokers.

Furthermore, the system may comprise computers under the control of only the practitioner, or it may comprise other computers as well, such as computers owned and/or operated by account holders, signal providers, and/or brokers. The system may further comprise storage media, typically as part of one or more computers, that comprise one or more databases of information relating to accounts of account holders. Within the context of the computer system, the various pieces of hardware and software may be interconnected by any suitable means, such as through physical, electromagnetic, or logical connections. Those of skill in the art are capable of designing and implementing any number of configurations of systems according to the present invention without undue experimentation. Accordingly, the details of construction of the systems need not be detailed herein.

In certain embodiments, the systems of the invention comprise adequate hardware and software to allow for communications between account holders and the hub, between signal providers and the hub, and between the hub and brokers that can execute trades in financial markets, such as foreign exchange markets. Communications may be by any convenient means, but are typically by way of e-mail, access of web pages on the Internet, text messaging, instant messaging, or telephony. In preferred embodiments, communications between signal providers and the hub are by e-mail. In preferred embodiments, communications between account holders and the hub are by access of a secure web page comprising part of the system. In preferred embodiments, communications between the hub and brokers is by e-mail.

In yet another aspect, the invention provides a method of doing business using a computer. For example, it provides a method of doing business using the Internet. In general, the method comprises: a) providing a system according to the invention, and charging a fee for providing the system. While any number of entities may be charged for providing of the system, in general, brokers are charged. Typically, the system and the services it provides are free for account holders, although in embodiments, account holders are charged a fee. In some embodiments, both brokers and account holders are charged a fee.

The methods and systems of the present invention are a convenient and efficient way for investors to trade in financial markets. It is well understood in the art that many individuals with available capital to invest refrain from trading in financial markets because they do not have the time to monitor the markets in order to make wise investments, and/or they do not have the time to learn or develop successful trading strategies. The present invention addresses the need in the art for entry of these individuals into the financial markets by providing a system and method that allows them to trade without a significant investment of time in learning details of the financial market and in following the markets. Rather, using the present systems and methods, the investors open accounts and rely on the expertise of signal providers to decide when and what kind of trades to make.

By increasing the number of investors in financial markets, the present systems and methods increase the volume of trading for brokers in those markets. In return for increased volume, brokers are willing to pay those implementing and administering the present systems and methods a fee. Accordingly, the present invention provides a way to generate revenue using computers, and in particular the Internet. In the method, brokers make revenue by way of increased volume. Furthermore, those implementing the systems and methods of the invention generate revenue by receiving a fee from the brokers. Where this fee is negotiated to be adequate, there is no need to charge account holders for the services provided. Thus, in those situations, account holders save the cost of enrollment, which is another way of obtaining a monetary benefit.

Further, signal providers may receive a portion of the fees provided by the brokers to those implementing the systems and methods of the present invention. Signal providers can receive payment for the information that they provide in any number of ways, such as, but not limited to, per trade recommended, per trade executed based on their advice, or on a flat-fee basis. Those practicing the methods of the invention are free to select the compensation method most suitable for each provider under each situation encountered.

The manner by which compensation is delivered to the recipient (e.g., to those implementing the system of the invention, or to signal providers) is not critical, and any suitable manner is envisioned by the invention. For example, a broker may transfer funds to a bank account of those practicing the invention on a daily basis, weekly basis, or monthly basis. Likewise, the transfer may be by paper (e.g., a check or bank draft) or by simple electronic funds transfer. Likewise, compensation to the signal providers may be by any suitable means. Typically, funds transfers to signal providers is provided by the entity implementing the systems of the present invention; however, payments may come directly from brokers or may be paid by account holders.

One exemplary method of doing business according to the invention comprises: a) providing a computer system that i) maintains a database of parameters relating to trading in one or more financial markets by one or more account holders, ii) receives information from one or more signal providers relating to trading in one or more financial markets, iii) consults the database(s) to determine trades to be made for account holders based on the information received, and how much to trade, and iv) orders brokers for the account holders for which trades are to be made to execute those trades; and b) charging users of the system a fee for use.

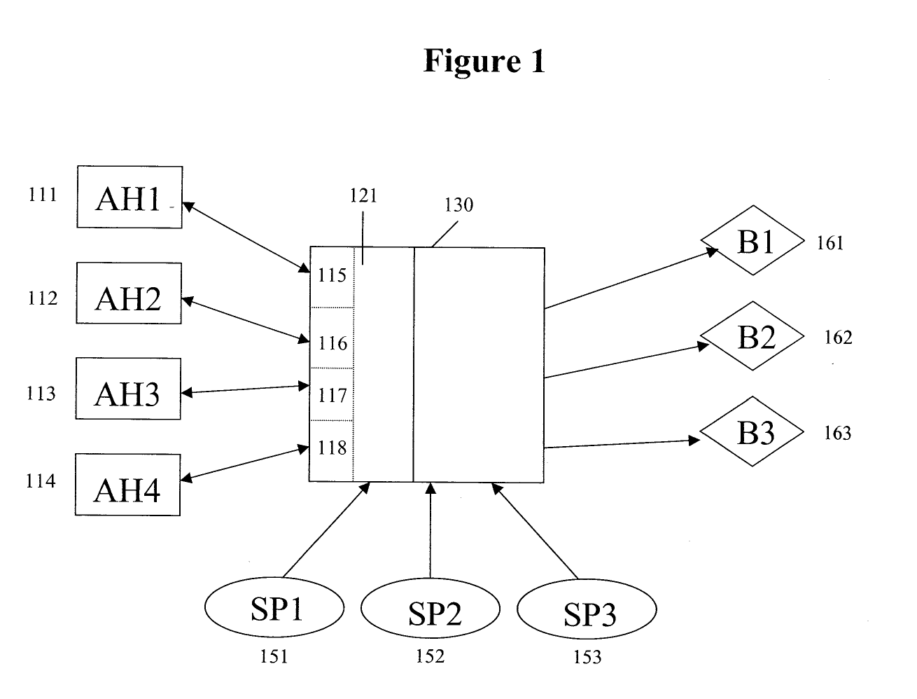

Turning now to the figures, which depict exemplary embodiments of the invention and are not to be considered as limiting the invention in any way, FIG. 1 depicts a flow chart of one embodiment of the method of the invention. In the figure, four account holders, AH1-AH4 (111,112,113,114), are depicted, three signal providers, SP1-SP3 (151,152,153), are depicted, three brokers, B1-B3 (161,162,163,) are depicted, and a single device (130) is depicted. In the method, account holders 1-4 (111,112,113,114) independently and confidentially open accounts on device 130 by supplying information and responding to queries present on one or more web pages (not depicted) provided by device 130, resulting in each obtaining individual accounts (115,116,117, and 118, respectively). Signal providers 1-3 (151,152,153) are given access to device 130 by way of e-mail addresses that are specifically provided independently for each signal provider. Signal providers 1-3 (151,152,153) periodically and independently provide advice on trading in foreign exchange markets by sending e-mails to device 130. Device 130 identifies the sender of the e-mail, consults database 121, which comprises accounts 115,116,117, and 118 and which, in this example comprises part of device 130, to determine which of account holders 1-4 (111,112,113,114) desires to execute trades based on advice from the signal provider sending the e-mail, and sends an e-mail to one or more of brokers 1-3 (161,162,163), instructing the broker(s) to execute trades for account holders 1, 2, 3, or 4. Flow of information in the method is indicated by directional arrows.

As can be seen from this figure, the device acts as a hub for receipt of and sending of information from and among account holders, signal providers, and brokers. Multiple account holders may order trades based on information received by multiple signal providers, and those trade orders may be executed by the brokers for each account holder based on the orders submitted to the brokers by the device. The method is capable of determining which account holders desire to trade based on information from each respective signal provider, and is capable of placing the appropriate orders to the appropriate brokers for the account holders using the information in its database, which links account holders to their chosen signal providers and to their respective brokers.

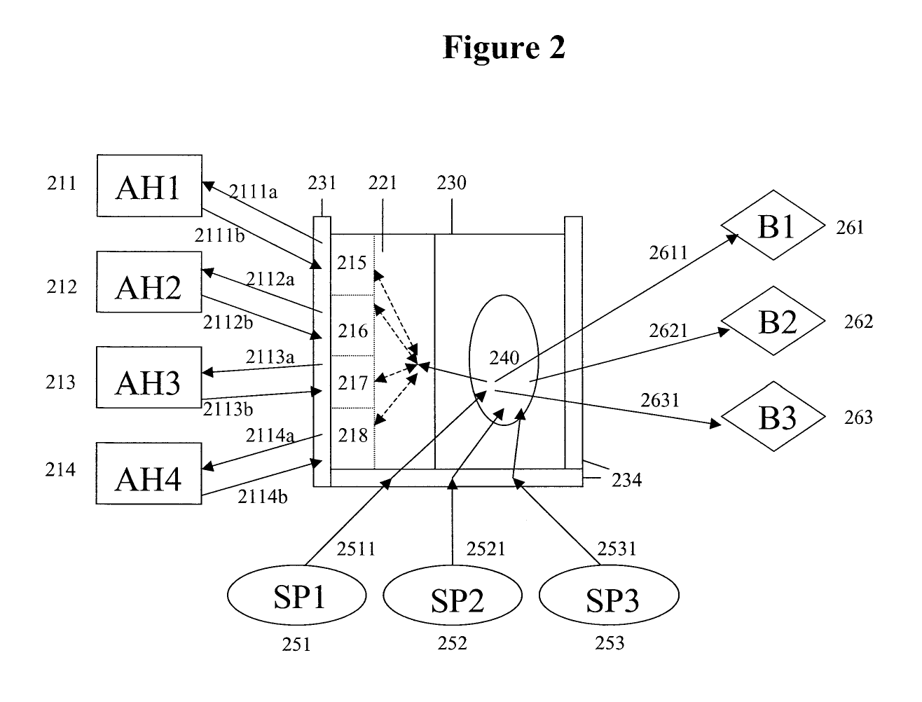

As discussed above, the method of the invention can be implemented as part of a system of the invention. An exemplary system of the invention is depicted in FIG. 2. The system comprises four account holders, AH1-AH4 (211,212,213,214, respectively), who independently hold four accounts, A1-A4 (215,216,217,218, respectively) with the system. Data pertaining to each account is received by server 230 through interface 231, which is a web page or series of web pages. The data for each account is maintained in database 221, which in this example, comprises part of server 230. Server 230 further comprises processor 240 for processing information, including but not limited to communications and data. The system also comprises signal providers SP1-SP3 (251,252,253, respectively). Information provided by signal providers SP1-SP3 (251,252,253, respectively) is received by server 230 through interface 234, which in this example is an e-mail application. The system further comprises brokers B1-B3 (261,262,263, respectively). Orders for trades in one or more financial markets are sent to brokers B1-B3 (261,262,263, respectively) through interface 234, which in this case is an e-mail application.

In practice, in this example the system orders trades for account holders from their respective brokers based on advice provided by the signal providers. Initially, account holders AH1, AH2, AH3, and AH4 provide information to the system through a series of web pages 231, where the information relates to the account holders' identities, trading preferences, and other information useful to the system. Information is provided in a two-way, interactive fashion by way of communications 2111a and 2111b (for AH1), 2112a and 2112b (for AH2), 2113a and 2113b (for AH3), and 2114a and 2114b (for AH4). The resulting accounts, A1, A2, A3, and A4, and the data relating to each, are maintained in database 221.

In this example, the system further comprises three e-mail accounts (not depicted) in e-mail application 234, one for each of three signal providers, SP1, SP2, and SP3 (251,252,253, respectively). While e-mail application 234 is capable of both receiving and forwarding e-mail messages, in this example, e-mail application 234 receives e-mails from SP1, SP2, and SP3, but does not send e-mail messages to them.

E-mail messages are periodically sent from SP1, SP2, and SP3 as communications 2511, 2521, and 2531, respectively. These messages contain advice on trades to execute in a financial market. Upon receipt of an e-mail from SP1, SP2, or SP3, processor 240 executes instructions in e-mail application 234 to understand the information provided by the e-mail message. In this example, a message has been sent by SP1 (251) via 2511, and the message states in the subject line Buy USD/JPY.

Upon receipt of the message from SP1, processor 240 consults database 221 to determine which accounts execute trades based on advice from SP1. Processor 240 identifies the appropriate accounts and determines what type of action to take (e.g., follow advice, do opposite of advice, follow advice if price is greater than US$1,000, follow advice and trade 2 lots, etc.). Processor 240 further identifies the brokers for each account for which a trade is to be made, and sends an e-mail to those brokers who should execute trades. In the present example, brokers B1, B2, and B3 (261,262,263, respectively) are associated with one or more of AH1, AH2, AH3, and AH4, and e-mail communications are sent to the brokers through communications 2611, 2621, and/or 2631. In this example, AH1 and AH2 choose to trade based on advice from SP1. However, AH1 has elected to follow the advice of SP1, whereas AH2 has elected to do the opposite of the advice of SP1. In addition, in this example, AH1 uses broker B1, while AH2 uses B3.

Once processor 240 has determined which accounts to trade, which brokers are associated with each account, and what type of trade to make, processor 240 sends two e-mails by way of e-mail program 234. One e-mail is sent to B1 via 2611, instructing him to buy U.S. dollars and sell Japanese yen for AH1, in the amount specified by AHl. Another e-mail is sent to B3 via 2631, instructing him to sell U.S. dollars and buy Japanese yen for AH3.

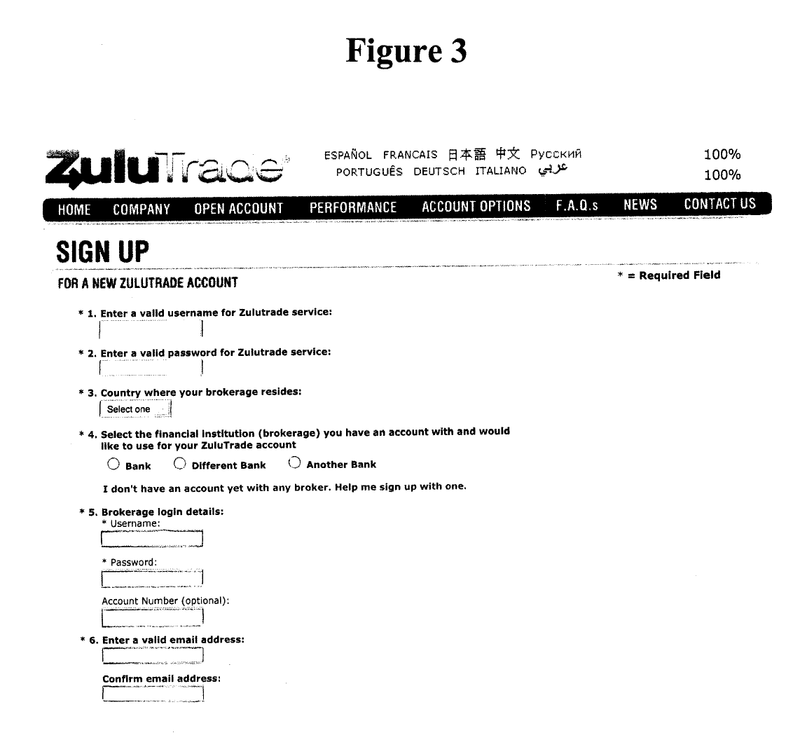

The system of the invention can comprise one or more web pages as interfaces between account holders and the system. An exemplary web page for a user to sign up for the services provided by the methods and systems of the invention is depicted in FIG. 3. In this figure, the system is referred to as “ZuluTrade”, and various information to be used in setting up an account, including uniquely identifying information for the user, is collected by way of text boxes to be completed by the user, and by buttons that may be selected by the user. As depicted in this figure, text box 1 provides a place for the user to enter a uniquely identifying username. The user may select any username desired, and the system and method determine if that username is unique to the system. If it is, the username is assigned to the user; if it is not, the user is informed that the desired username is not available, and the user is prompted to enter another username.

Text box 2 of FIG. 3 provides a provides a place for the user to enter a uniquely identifying password. The user may select any password desired, although in some embodiments, the password must satisfy certain criteria (length, presence of both letters and numbers, etc.). Upon entry of the password, the system and method store the combination of username and password in a database. In embodiments where the password must satisfy certain criteria, the system and method first confirm that the criteria are met before storing the combined information in the database.

Drop-down box 3 of FIG. 3 provides the user the opportunity to identify the location of his brokerage, and radio buttons 4 allow the user to identify the brokerage by name. It is to be understood that the system will permit any number of brokerages to participate in the system, and the number of radio buttons will correspond to the number of brokerages. In this example, three fictitious brokerages are listed as “bank”, “Different Bank”, and “Another Bank”. If the user has no brokerage at this time, the system and method provide a link under radio buttons 4, that allow him to open an account with a brokerage that participates in the system. In this way, not only does the sign-up page allow for users to enroll in the system of the invention, but brokers that participate in the system are provided opportunities to increase their customer base.

Upon obtaining an account with a broker that participates in the system, the user is prompted at drop-down boxes 5 to enter uniquely-identifying information regarding his brokerage account. In this way, secure communication between the system and the brokerage can occur, without the need for intervention by the user.

Finally, text boxes 6 provide the user the ability to identify any e-mail address for communication between the system and the user. Upon confirmation of the validity of the e-mail address, communications between the system and the user are initiated.

Upon entry of the information requested on the sign-up web page, and confirmation of the validity of the information, the user is assigned an account with the system, and becomes an account holder. The system is very versatile, and account holders may update or otherwise change their information at any time.

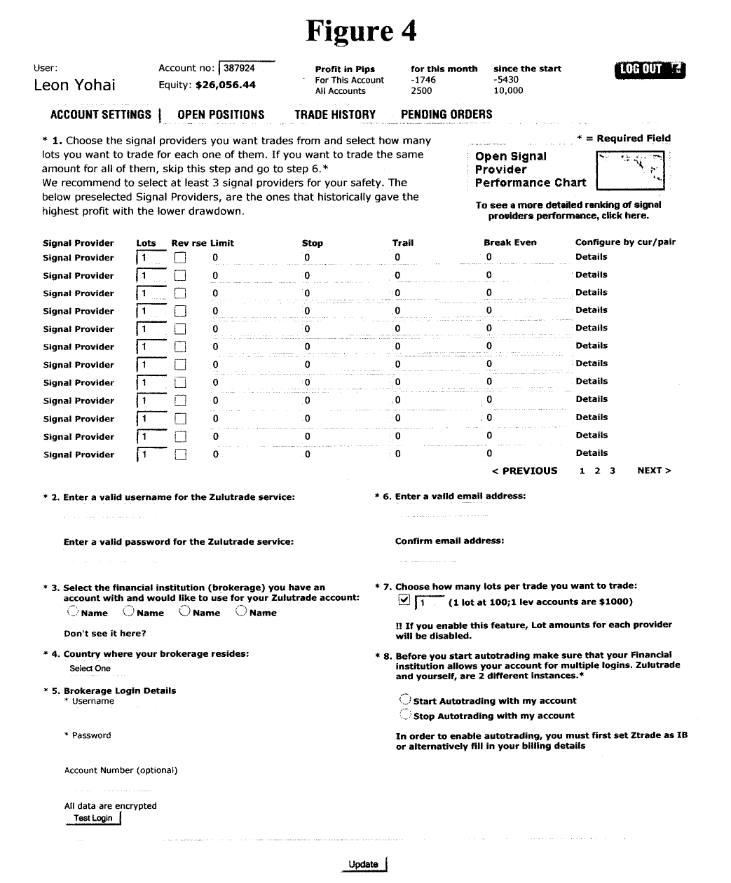

Another exemplary web page that may be provided by the system of the invention is shown in FIG. 4. In this web page, an account holder may select from among numerous parameters to develop a trading strategy to suit his needs. The web page depicted shows various parameters that may be selected for setting up an account holder's account, and also indicates various other types of information that can be made available to the account holder, such as information regarding his open positions, his trade history, and his pending orders, all of which are provided as separate web pages and provide detailed information and analyses of the account, the signal providers available for selection, and other data relating to trading in financial markets.

In section 1 of FIG. 4, the account holder is provided with the option of selecting one or more signal provider to rely on for advice regarding trading in one or more financial market. For the purpose of illustration, the figure indicates “signal provider” for all signal providers; however, in operation, each line will have the specific name or label for each individual signal provider associated with the system. As can be seen from the figure, various parameters for trading for each signal provider may be set, such as the number of lots to trade, the limit, the stop, the trail, and the break-even. One particular parameter that may be elected is the option to “reverse” trade. In this option, the account holder has elected to make the opposite trade as that recommended by the selected signal provider. As can be seen from the figure, the system and method provide a very powerful way to implement an investment strategy. For example, the system and method may allow an account holder to trade according to (or reverse of) a signal provider's recommendations up to a pre-set limit, then close the trade (or reverse it). Of course, that is just one example of the many permutations of trading parameters that may be selected, and numerous parameters may be selected to fine-tune the trading strategy. In addition, as can be seen at the bottom of the screen-shot, an account holder has the option to revise and update the parameters at any time to even better fine-tune the investment strategy.

To ensure that a selected trading strategy is properly associated with an account holder, text boxes 2 are provided to identify the account holder to the system. It is to be noted here that a particular user may have multiple accounts with the system under different usernames. The accounts may be associated with different brokers, allowing for diversification of a portfolio. In conjunction with the username for the system, the account holder selects the appropriate account number, which is provided as a text box or drop-down box at the top of the page.

In addition, to ensure proper correlation of selections with accounts and brokerages, radio buttons 3 provide the account holder the opportunity to identify the brokerage associated with the account. It is to be noted here that, for illustration purposes, the brokerages are all labeled “Name”; however, in practice, each radio button will have the actual name of a financial institution associated with the system. As with the sign-up page, if the institution of interest is not available, the system provides the account holder with a link to set up an association with a brokerage linked to the system or request that his brokerage become associated with the system. In addition, drop-down box 4 provides the account holder the opportunity to identify the country where the brokerage resides.

To ensure that trades are executed, in text boxes 5 account holders are asked to provide uniquely identifying information regarding their brokerage accounts. The account holder's e-mail address is required to be provided in text boxes 6.

For ease of portfolio management, check box and drop-down boxes 7 are provided to allow the account holder to override the lot selections of section 1, and set lot trading to be identical for all signal providers selected. As mentioned above, the parameters available in the system can be altered at any time; therefore, account holders may select this option and de-select it as desired.

Radio buttons 8 are execute buttons that allow account holders to start and stop services provided by the system. Actual submission of changes to the account parameters are uploaded to the system by selecting the “Update” button at the bottom of the page.

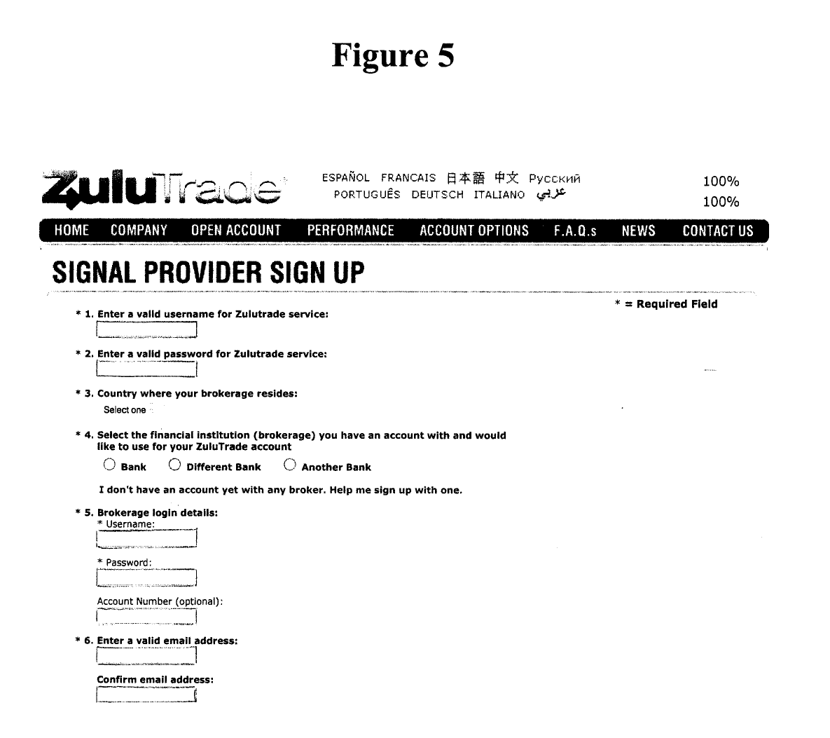

FIG. 5 depicts a screen shot of an example of a web page for a signal provider to enroll with the system. As with account holders, signal providers are asked in text boxes 1 and 2 to enter a username and password. If the username and password are valid, the combination is stored in a database for future reference. Drop-down box 3 and radio buttons 4 are provided for the signal provider to indicate the location of a brokerage with which the signal provider is associated. As discussed below, it is not required that a signal provider be associated with a brokerage. Brokerage account information for each signal provider is collected in text boxes 5, in order for the system to verify the identity of the signal provider and confirm his association with brokerages. Finally, text boxes 6 provide the signal provider the opportunity to indicate to the system an e-mail address to be associated with his profile. Although the system is not limited to receipt of communications from signal providers by way of e-mail, in the embodiment depicted in this figure, communications from the signal provider will be identified and processed using the e-mail address provided. That is, in this embodiment the only identifying information needed from the signal provider is the e-mail address supplied at this point. The system will recognize all e-mails from this e-mail address as originating from this particular signal provider, and will execute trades for account holders who have selected this signal provider based on the advice contained in the e-mail. For example, an e-mail from a particular signal provider (identified by way of his e-mail address) may simple state in the subject line “buy USD/EUR”. Based solely on this information and the information contained in the database(s) for each account holder, the system can automatically identify the signal provider, the advice given (captured from the subject line), the account holders that want to trade based on advice from the signal provider, the type of trade to execute for each account holder, the amount to trade, and the brokerage for each account holder. The system can then automatically order trades from all of the appropriate brokerages and update each affected account accordingly.

In some embodiments, the signal provider sign up page provides the signal provider the ability to submit a brief strategy description. This description will assist account holders in making the decision as to whether to trade based on the advice of the signal provider. In essence, the system provides the account holder as much relevant information on signal providers and financial markets as possible to assist in setting up trading preferences and managing portfolios.

While it is not required that a signal provider have an association or “track record” with a brokerage, the system will note for account holders those signal providers without any associations or verifiable histories. Typically, the system will provide ratings or some other indication of the performance of each signal provider. This information can assist account holders in selecting signal providers and amounts to trade based on advice from each signal provider.

Other types of information that may be provided, for example by way of web pages, include, but are not limited to, details relating to all open positions of an account holder, such as the financial market in which trades are open, the dates and times the trades were added, the number of lots trading, the type of trade (e.g., buy or sell), the entry position, the stop position, the limit, the current rate, portfolio profit or loss, and the corresponding signal providers. Furthermore, for example, merged positions in each market or for each trade can be presented, along with the number of lots trading. In addition, signal provider performance over any period of time, in numerous graphical or numerical forms, can be displayed. Likewise, for example, the trade history of each signal provider can be presented graphically or numerically, with any number of parameters indicated, such as pips/lots, % return on investment, win trades, and total profit. These data can be mapped to individual accounts, for example, to give the account holders a better understanding of how their portfolios are performing over time or over certain windows of time, including performance of each signal provider as he relates to the holder's particular investments. Another non-limiting example of a web page that can be provided in embodiments is one that shows the open positions of the account, which can be detailed based on the market and type of trade (e.g., type of currency to be traded), the entry, type, date added, lots, stop, limit, signal provider, dates orders are valid, reentry stop, reentry limit, and side, among other things. In essence, the type and amount of information and analyses that can be presented to the account holders, for example by way of web pages, is unlimited, as the above non-limiting examples indicate.

It will be apparent to those skilled in the art that various modifications and variations can be made in the practice of the present invention without departing from the scope or spirit of the invention. Other embodiments of the invention will be apparent to those skilled in the art from consideration of the written description and figures, and in practice of the invention. It is intended that the written description be considered as exemplary only, with a true scope and spirit of the invention being indicated by the following claims.

1. A method of trading in one or more financial markets, said method comprising:
providing at least one computing device that is connected to the Internet;
providing access to the device for one or more local computers used by one or more account holders;
providing access to the device for one or more signal providers; and
communicating with one or more brokers for the account holders,
wherein communicating comprises sending orders to the broker(s) for one or more trades in one or more financial markets for the one or more account holders.

2. The method of claim 1, wherein an order is based, at least in part, on advice or other information provided by at least one signal provider.

3. The method of claim 2, wherein an order is based, at least in part, on following the advice of at least one of the signal providers.

4. The method of claim 2, wherein an order is based, at least in part, on following the opposite of the advice of at least one of the signal providers.

5. The method of claim 1, comprising:
placing orders for two or more trades with two or more brokers for two or more account holders.

6. The method of claim 1, wherein providing access to the device for one or more local computers used by one or more account holders comprises providing secure access to a web page on the Internet.

7. The method of claim 1, wherein providing access to the device for one or more signal providers comprises providing one or more e-mail addresses to which signal providers may send advice or other information.

8. The method of claim 1, wherein communicating with one or more brokers for the account holders comprises sending an e-mail to the broker(s).

9. The method of claim 1, wherein the method is a method of trading in foreign exchange markets.

10. Computer software comprising instructions for execution of the method of claim

11. A method of trading in a financial market, said method comprising:
selecting one or more signal providers to provide periodic advice on trading in a financial market;
selecting an amount to trade based on the advice of each signal provider selected;
optionally selecting other parameters for trading;
permitting an automated system that receives advice from multiple signal providers to automatically order trades,
wherein the trades are ordered based on the advice of the signal provider(s) selected, the amount to trade selected, and optionally other selected parameters.

12. The method of claim 11, wherein the market is a foreign exchange market.

13. The method of claim 11, wherein trades are ordered at least in part based on following the advice of at least one of the signal providers.

14. The method of claim 11, wherein trades are ordered at least in part based on executing trades that are opposite of the advice of at least one of the signal providers.

15. The method of claim 11, wherein selecting one or more signal providers comprises selecting two or more signal providers.

16. The method of claim 11, which is a method of hedging and comprises:
selecting two signal providers having historical records that complement each other.

17. Computer software comprising instructions for execution of the method of claim 11.

18. A system for on-line trading in a financial market, said system comprising:
at least one computer that is connected to the Internet; and
software comprising computer-readable instructions to execute a method comprising:
obtaining information regarding at least one account holder and one or more parameters for trading of funds for the account holder(s),
wherein at least one of the parameters is identification of one or more signal providers upon whose advice trades should be made;
storing the information regarding the account holder(s) and parameter(s) in at least one account per account holder;
obtaining information from at least one signal provider, wherein the information relates to a trade in a financial market;
retrieving information from each account to determine if a trade should be made for the account based on the identity of the signal provider(s); and
automatically ordering a trade to be made by at least one broker for the account holder(s) having accounts that indicate that a trade should be made for the account based on the identity of the signal provider(s).

19. The system of claim 18, which comprises at least one database comprising the information regarding at least one account holder and one or more parameters for trading of funds for the account holder(s).

20. The system of claim 18, comprising at least two computers.

21. The system of claim 18, comprising more than one signal provider and more than one account.

22. The system of claim 18, wherein obtaining information from at least one signal provider comprises receiving an e-mail from the signal provider(s).

23. The system of claim 18, wherein the system can obtain information from a single signal provider and automatically order trades for multiple account holders.

24. The system of claim 18, wherein each account can independently comprise parameters indicating that trades should be made based on advice provided by more than one signal provider.

25. The system of claim 18, wherein trades are ordered based on following advice provided by one or more signal providers.

26. The system of claim 18, wherein trades are ordered based on taking the opposite action of the advice provided by one or more signal providers.

27. The system of claim 18, comprising executing by at least one broker the trades that are automatically ordered.

28. The system of claim 18, wherein obtaining information regarding at least one account holder and one or more parameters for trading of funds for the account holder(s) occurs before all other actions, allowing the system to order trades without real-time input from the account holder(s).
